(19) United States
(12) Patent Application Publication
(10) Pub. No.: US 2024/0392851 A1
(43) Pub. Date: Nov. 28, 2024

(54) APPARATUS AND METHOD FOR REAR BRAKE COOLING

(71) Applicant: POLESTAR PERFORMANCE AB, Göteborg (SE)

(72) Inventor: Charalampos MAKRYGIANNIS, Royal Leamington Spa (GB)

(21) Appl. No.: 18/554,410

(22) PCT Filed: Apr. 8, 2022
(86) PCT No.: PCT/US2022/071631

§ 371 Date: Oct. 6, 2023

Related U.S. Application Data
(60) Provisional application No. 63/173,111, filed on Apr. 9, 2021.

(51) Int. Cl. F16D 65/78; B60T 5/00

(52) U.S. Cl. CPC F16D 65/78; B60T 5/00

(57) ABSTRACT

A deployable rear brake cooling system to provide cooling air flow to rear brake assemblies so as to maintain rear brake performance. The deployable rear brake cooing system can operate based on forces experienced during braking events without any input from a driver or an automobile's onboard control and sensor suite or alternatively, the deployable cooling system can be designed to deploy based on parameters measured by the automobile's onboard control and sensor suite, wherein said deployment is triggered by an output from the control suite to a selectively controllable actuator on the cooling system.

### PRIORITY CLAIM

The present application claims priority from U.S. Provisional Application No. 63/173,111, filed Apr. 9, 2021, which is hereby fully incorporated herein by reference.

### TECHNICAL FIELD

The present application is directed to an apparatus and related methods for maintaining automotive brake performance. More specifically, the present invention is directed to a cooling apparatus for maintaining rear brake performance on an EV (Electric Vehicle) while simultaneously limiting any degradation to EV range.

### BACKGROUND

It is well understood that brake performance on automobiles is degraded as brake components increase in temperature. In a traditional friction braking design, kinetic energy is converted to heat as the braking system is engaged and when the brake components operate at elevated temperatures, braking performance is negatively impacted. For this reason, high performance and race cars can be specifically designed to channel or direct airflow toward the braking components and to increase a rate of heat dissipation from the braking components.

Currently, a large emphasis is being placed on developing and bringing EV's (Electric Vehicle's) to the commercial and consumer market. One of the primary drivers impacting EV acceptance is the driving range currently available with today's rechargeable battery technology. While EV batteries are evolving quickly, the availability of publicly available charging devices and the speed at which battery charging occurs means that driving range will continue to be one of the driving forces in EV design in the near term. As such, it would be advantageous to develop a system that combined the benefits of maintaining lower brake temperatures with the ability to maintain acceptable driving ranges

### SUMMARY

Embodiments of the present invention address the desires of maintaining both brake performance and EV driving range through the use of a cooling system that deploys one or more air ducts for cooling the rear brakes under targeted driving conditions. In some embodiments, the cooling system can be designed to mechanically deploy one or more ducts based on forces experienced during braking events without any input from a driver or an automobile's onboard control and sensor suite. In some embodiments, the cooling system can be designed to deploy one or more ducts based on parameters measured by the automobile's onboard control and sensor suite, wherein said deployment is triggered by an output from the control suite to a selectively controllable actuator on the cooling system. In some embodiments, a driver can selectively adjust handling characteristic of the EV such that the parameters by which the control suite evaluates the deployment of the cooling system are adjusted or such that deployment of the cooling system is prevented. In some embodiments, use of the disclosed cooling system can allow for the rear brake size and mass to be reduced so as to reduce overall mass of the EV and to extend the driving range without negatively impacting brake performance.

In one aspect, the present invention is directed to a mechanically deployed cooling system that does not require input from a driver or an EV control suite in order to deploy. In some embodiments the mechanically deployed cooling system can be mechanically integrated into a bottom panel or as part of a rear suspension system. Regardless of mounting orientation, the mechanically deployed cooling system can comprise one or more air ducts operably connected to a duct hose, wherein a discharge end of the duct hose is proximate a rear brake assembly. Generally, the air duct is configured to deploy downward and below a plane defined by the bottom panel when the EV is under braking due to the weight transfer toward a front of the EV and corresponding lifting of a rear of the EV. In one representative embodiment, the air duct can be rotatably integral to the bottom panel, using for example a hinge mount, such that a duct opening rotatably drops into an airstream passing below the EV. In another embodiment, the air duct can be attached to a rotatable or otherwise deployable arm that is configured to operate in opposition to the rear suspension such the deployable arm directs the duct opening below the bottom panel and into the airstream below the EV. In some embodiments, the air duct can include an adjustable assembly for example, springs and/or tensioners that allow the force at which the air duct deploys to be adjusted. In some embodiments, the adjustable assembly can be manually configured by a user or service professional or alternatively, the adjustable assembly can be “automatically” configured by selection of a performance mode or as a result of continual analysis and adjustment by an EV control suite.

In another aspect, the present invention is directed to a deployable cooling system that is deployed by an actuator at the direction of an output from an EV control suite. Generally, the EV control suite directs the actuator to position an air duct into an air stream below the EV under specified driving conditions. In some embodiments, the specified driving conditions can be manually selected by a driver through the selection of a driving mode, for example, an extended range mode, high performance mode or even track mode that impacts overall driving characteristics of the EV. For example, the control suite may prevent deployment of the air duct during the extended range mode so as to avoid negatively impacting the aerodynamic characteristics of the EV or alternatively, deploying the air duct in almost every braking event in a track mode so as to proactively cool the rear brakes and to ensure continued performance under spirited driving conditions. In some embodiments, the EV control suite can make use of a variety of vehicle sensors monitoring conditions such as brake temperatures, rates of acceleration and deceleration and the like whereby the EV control suite recognizes the need for deployment of the air duct and the corresponding rear brake cooling provided by deployment of the air based on certain monitored conditions. In some embodiments, the EV control suite can deploy the air duct directly from a bottom panel or alternatively as a component of a rear suspension or rear brake system.

In yet another aspect, the present invention is directed to a method of cooling rear brakes of an EV while at the same time maintaining driving range. The method can comprise the step of deploying at least one air duct into an air stream below a bottom panel of the EV under desired parameters. The method can further comprise the step of directing air collected in the at least one air duct to a rear brake assembly to remove heat and thereby cool the rear brake assembly to maintain brake performance. The method can further comprise monitoring one or more performance or vehicle status parameters with a control and sensor suite, whereby the at least one air duct can be deployed with an actuator at the direction of the control suite. Representative performance or vehicle status parameters can include, for example, rear brake temperature, rates of acceleration and deceleration or a driving mode, such as an extended range, high performance or track mode, that can be manually selected by a driver. In one representative embodiment, the method of deploying can comprise an automatic, mechanical deployment of the at least one air duct when the EV experiences specified driving forces, for example, when the rear of the EV lifts upward under braking as weight transfers to a front end of the EV. Representative mechanical deployments can include a hinged deployment of the air duct from a bottom panel or by lowering a deployable arm such that the air duct is extended below the bottom panel.

In certain aspects of the present invention, a method for reducing an overall weight of an EV can include providing a rear brake cooling assembly such that a brake mass of a rear brake can be reduced due to increased heat transfer from the rear brake. The method can comprise positioning an air duct of the rear brake cooling assembly into an air stream below a bottom panel such that air can be directed onto the rear brakes.

In another aspect of the present invention, a method of extending a driving range of an EV can comprise including a deployable rear brake cooling assembly. The method can comprise deploying the rear brake cooling assembly only under specific conditions so as to maintain advantageous air flow characteristics, for example, laminar air flow conditions underneath the EV, when cooling of the rear brakes is not required. The method can further comprise reducing a brake mass of the rear brakes by providing additional cooling to the rear brakes with the deployable rear brake cooling assembly when heat must be dissipated to maintain desired performance of the rear brakes.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is bottom view of an Electric Vehicle (EV) including a pair of deployable cooling systems according to an embodiment of the present invention.

FIG. 2 is a perspective view of a deployable cooling system of the present invention mounted in a bottom surface of the EV according on an embodiment of the present invention.

FIG. 3 is a perspective view of the deployable cooling system of FIG. 2 illustrating a transition between a non-deployed disposition and a deployed disposition.

FIG. 4 is a side view of the deployable cooling system of FIG. 2 in the deployed disposition.

FIG. 5 is a front view of the deployable cooling system of FIG. 2 in the deployed disposition.

FIG. 6 is a perspective view of an embodiment of a deployable cooling system of the present invention illustrating the transition between the non-deployed disposition and the deployed disposition.

FIG. 7 is a side view of the deployable cooling system of FIG. 6 illustrating the transition between the non-deployed disposition and the deployed disposition.

FIG. 8 is a perspective view of wheel well illustrating a distribution outlet of a deployable cooling system relative to a rear brake assembly according to an embodiment of the present invention.

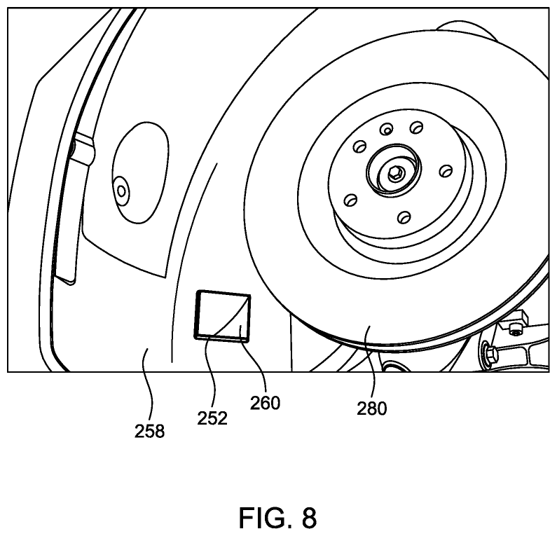

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

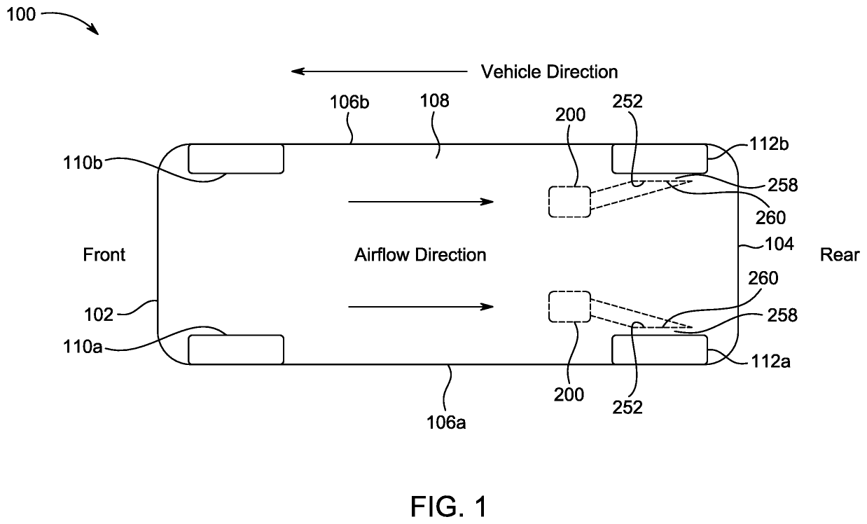

Referring now to FIG. 1, an Electric Vehicle (EV) 100 is shown in a bottom view depicting a vehicle front 102, a vehicle rear 104, vehicle sides 106a, 106b and bottom surface 108. Bottom surface 108 is generally defined by a number of features including, for example, a lower battery tray, skid plates and other individual surfaces that preferably defines a generally planar surface so as to be aerodynamically efficient and reduce drag that can impact efficiency and range of EV 100. Generally, the EV 100 includes a pair of front tires 110a, 110b and a pair of rear tires 112a, 112b. Proximate each rear tire 110a, 110b, EV 100 includes a deployable cooling system 200 that mounts within the bottom surface 108.

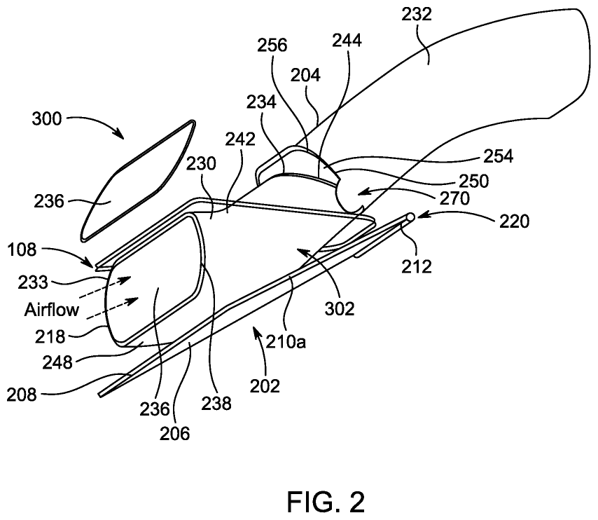

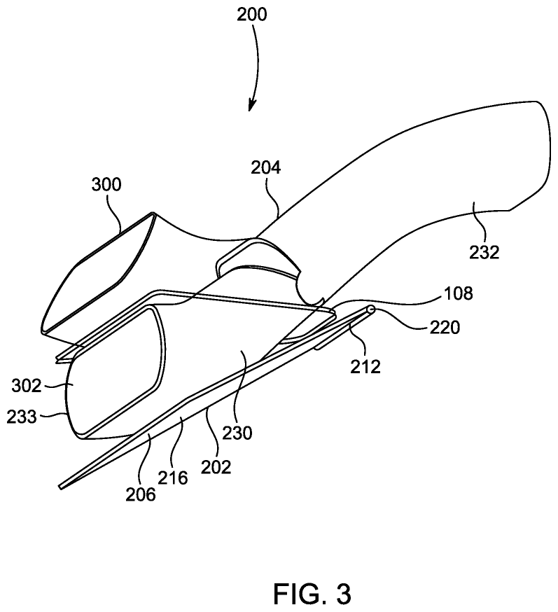

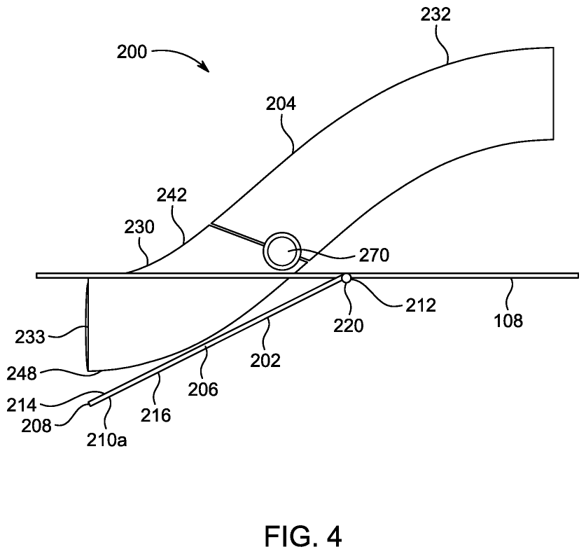

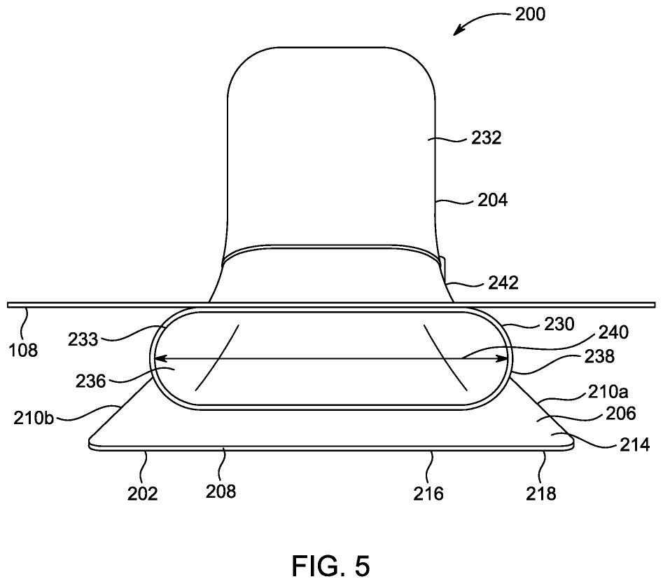

As shown in FIGS. 2, 3, 4 and 5, deployable cooling system 200 generally comprises a deployable assembly that can automatically or manually deploy downward in either a rotatable or slidable arrangement from the bottom surface 108. Deployable system 200 generally comprises a sealing flap 202 and a duct member 204. Sealing flap 202 can generally comprise a flap body 206 defined by a front edge 208, a pair of side edges 210a, 210b and a rear edge 212. Sealing flap 202 can comprise an upper flap surface 214 and a lower flap surface 216. Generally, flap body 206 can possess a body perimeter 218 generally defining a quadrilateral shape. Sealing flap 202 can comprise a hinge member 220 operably interconnecting the rear edge 212 with bottom surface 108. Sealing flap 202 is preferably constructed of a lightweight, corrosion resistant material such as, for example, aluminum or polymeric materials such as carbon fiber or fiberglass.

Referring again to FIGS. 2, 3, 4 and 5, duct member 204 can comprise an inlet portion 230 and a distribution portion 232. Generally, inlet portion 230 is defined between an inlet end 233 and a transition end 234. Inlet end 233 defines an inlet opening 236 having an inlet cross-section 238. An inlet width 240 of the inlet opening 236 is less than a width of the flap body 206 as defined between side edges 210a, 210b. Transition end 234 generally includes an arcuate or angled transition portion 242 with a transition opening 244 at the transition end 234, said transition opening 244 defining a transition cross-section 246. Inlet end 233 generally includes a bottom surface 248 that can be operably attached to the upper flap surface 214 using suitable fastening members or adhesives. In another alternative embodiment, the sealing flap 202 and inlet portion 230 can comprise a single piece, integral design in which the bottom surface 248 takes the form of sealing flap 202 and the inlet end 233 defines a scoop-like appearance.

Distribution portion 232 is defined between a receiving end 250 and a distribution end 252. Receiving end 250 defines a receiving opening 254 having a receiving cross-section 256 that preferably matches the transition cross-section 246. Distribution end 252 is generally located proximate a rear wheel well 258 such that a distribution opening 260 is proximate a rear brake assembly 280. Inlet portion 230 and a distribution portion 232 can be rotatably connected via a pivot assembly 270 that links the transition end 234 with the receiving end 250. With the inlet portion 230 and distribution portion 232 connected via pivot assembly 207, a continuous flow path 272 is defined between the inlet end 233 and the distribution end 252.

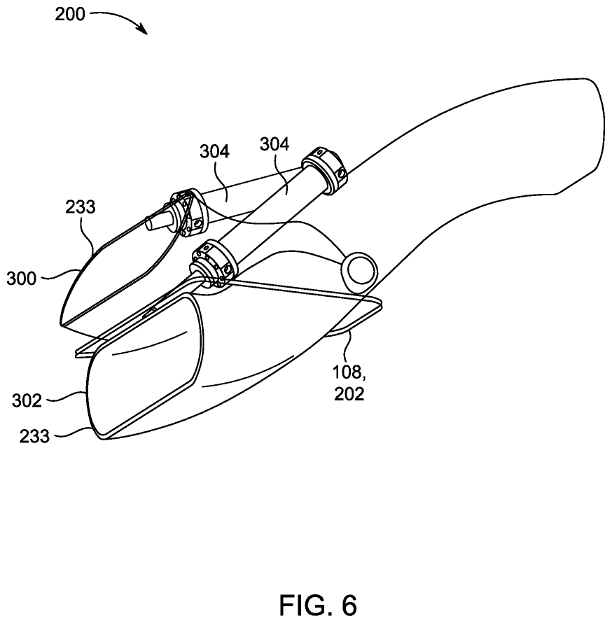

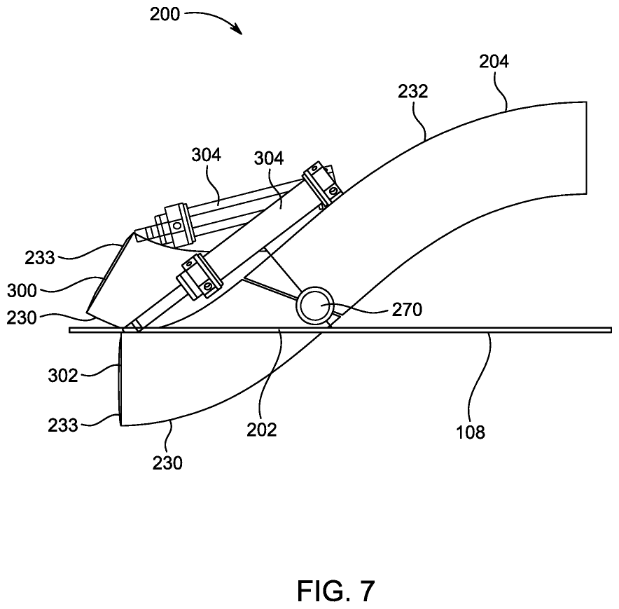

Generally speaking, deployable cooling system 200 can be manually or automatically deployed to direct cooling air to rear wheel well 258 and to cool the corresponding rear brake assembly 280. As such, deployable cooling system 200 operates by transitioning the sealing flap 202 between a non-deployed disposition 300 in which the sealing flap 202 is in an essentially flush, planar orientation relative to the bottom surface 108 and a deployed disposition 302 in which the front edge 208 of the sealing flap 202 has been directed downward from the bottom surface 108. In deployed disposition 302, the downward movement of the front edge 208 exposes the inlet opening 236 into the airflow path illustrated in FIG. 1. Sealing flap 202 can be directed downward using for example, an actuator 304, for example, a linear or rotary actuator or control arm, connected between the sealing flap 102 and one or more of a rear suspension component, the bottom surface 108 or the distribution portion 232 as shown in FIGS. 6 and 7.

When the inlet opening 236 is exposed to the airflow path, a cooling airflow is directed into the inlet opening 236 such that the airflow can flow through the inlet portion 230. Due to the rotational freedom provided by pivot assembly 270, the continuous flow path 272 is continually defined through the duct member 204 as the sealing flap 202, and consequently the inlet end 233 transitions between the non-deployed disposition 300 and the deployed disposition 302. As such, the cooling airflow is directed through the inlet portion 230, out the transition end 234 and into the receiving end 250 of the distribution portion 232. The cooling airflow traverses the length of the distribution portion 232, whereby the cooling airflow is directed through the distribution opening 260 and onto the rear brake assembly 280, whereby the reduced temperature of the cooling airflow relative to the rear brake assembly temperature allows heat to be convected/removed from the rear brake assembly 280. In certain embodiments, the introduction of cooling airflow onto the rear brake assembly from the distribution opening 260 can allow the overall size/mass of the rear brake assembly 280 to be reduced as braking performance degradation due to elevated brake temperatures is avoided, where reducing rear brake mass can be advantageous to extending EV range.

Operation of the deployable cooling system 200 can be accomplished in either a manual or automatic mode. As used herein, manual operation of the deployable cooling system refers to a manual driver input, whereby an EV driver can select a driving function that allows the deployable cooling system 200 to be in a cooling mode. In some instances, this manual driver input can comprise a button or switch in proximity to the driver's seat, for instance on a dashboard or center console, or alternatively, a selectable icon on a touch screen panel that is positioned for easy access by the driver. In some instances, the switch or selectable icon can be specific to operation of the deployable cooling system 200 or alternatively, the operation of the deployable cooling system 200 can be integrated into an overall vehicle performance package, for example a sport or performance mode, where elevated rear brake assembly temperatures may be expected or where an onboard processor determines that cooling of the rear brake assemblies 280 may be advantageous or required due to measured temperature parameters or based on recently measured vehicle parameters, such as rapid acceleration/braking that would be indicative of elevated rear brake assembly temperatures.

Automatic operation of the deployable cooling system 200 is generally intended to refer to braking or driving events that cause the deployable cooling system 200 to operate without any input from the EV driver. For instance, the deployable cooling system 200 can be configured to transition to deployed disposition 302 when the vehicle experiences braking events, whereby the rear suspension of the EV can be configured to deploy the deployable cooling system 200 beyond a certain physical threshold, i.e. movement of the suspension. Alternatively, the onboard processor can be configured such that deployable cooling system 200 is always deployed when certain temperature or driving parameters are exceeded.

As deployment of the deployable cooling system 200 can negatively impact the aerodynamics of the EV, both manual and automatic deployment of the deployable cooling system 200 can be configured such that deployment occurs intermittently only during braking events when the introduction of the deployable cooling system 200 into the airflow under the EV can be advantageous in assisting with deceleration and will not negatively impact EV range when braking is not occurring.

Embodiments of the present invention address the desires of maintaining both brake performance and EV driving range through the use of a cooling system that deploys one or more air ducts for cooling the rear brakes under targeted driving conditions. In some embodiments, the cooling system can be designed to mechanically deploy one or more ducts based on forces experienced during braking events without any input from a driver or an automobile's onboard control and sensor suite. In some embodiments, the cooling system can be designed to deploy one or more ducts based on parameters measured by the automobile's onboard control and sensor suite, wherein said deployment is triggered by an output from the control suite to a selectively controllable actuator on the cooling system. In some embodiments, a driver can selectively adjust handling characteristic of the EV such that the parameters by which the control suite evaluates the deployment of the cooling system are adjusted or such that deployment of the cooling system is prevented. In some embodiments, use of the disclosed cooling system can allow for the rear brake size and mass to be reduced so as to reduce overall mass of the EV and to extend the driving range without negatively impacting brake performance.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A deployable cooling system for rear brakes of a vehicle, comprising:
a sealing flap adapted for flush mounting in a vehicle bottom surface, said sealing flap being transitionable between a non-deployed disposition and a deployed disposition, and
a duct member defining a continuous flow path between an inlet end and a distribution outlet, said inlet end adapted to transition with the sealing flap and wherein the distribution outlet is positioned in proximity to a rear brake assembly of the vehicle.

2. The deployable cooling system of claim 1, wherein the duct member comprises an inlet portion and a distribution portion, said inlet portion including the inlet end and a transition end and the distribution portion including a receiving end and the distribution outlet, the inlet portion and the distribution portion being movably coupled at the transition end and the receiving end.

3. The deployable cooling system of claim 2, wherein the transition end and the receiving end are coupled with a pivot assembly.

4. The deployable cooling system of claim 1, wherein the sealing flap resides in a generally planar, flush orientation with the vehicle bottom surface in the non-deployed disposition.

5. The deployable cooling system of claim 4, wherein a front edge of the sealing flap is directed downward from the vehicle bottom surface to expose an inlet cross-section at the inlet end of the duct member to cooling airflow below the vehicle bottom surface.

6. The deployable seeing system of claim 5, wherein an actuator coupled between the vehicle bottom surface and the sealing flap directs the front edge downward from the vehicle bottom surface.

7. The deployable cooling system of claim 5, wherein a control arm coupled between a rear suspension assembly of the vehicle and the sealing flap directs the front edge downward from the vehicle bottom surface.

8. The deployable cooling system of claim 1, wherein the sealing flap is integrated into the duct member such that a bottom duct surface of the duct member proximate the inlet end defines the sealing flap.

9. An Electric Vehicle, comprising:
a pair of deployable cooling systems according to claim 1, each deployable cooling system positioned proximate a corresponding rear wheel well of the Electric Vehicle.

10. A method for cooling rear brakes of a vehicle, comprising:
positioning a deployable cooling system in proximity to each rear wheel well of the vehicle; and
deploying the deployable cooling system into airflow beneath the vehicle to direct the airflow onto a rear brake assembly located at each rear wheel well.

11. The method of claim 10, wherein positioning the deployable cooling system comprises:
mounting a sealing flap of the deployable cooling system in a flush, planar arrangement in a bottom surface of the vehicle.

12. The method of claim 11, wherein deploying the deployable cooling system comprises:
directing a front edge of the sealing flap downward from the bottom surface and into the airflow beneath the vehicle.

13. The method of claim 12, wherein directing the front edge of the sealing flap downward further comprises:
selecting a vehicle mode defining one or more parameters in which the front edge of the sealing flap is directed downward, said one or more parameters being monitored by a vehicle processor; and
providing an input from the vehicle processor to an actuator linking the sealing flap and the bottom surface such that the actuator directs the front edge downward.

14. The method of claim 12, wherein directing the front edge of the sealing flap downward further comprises:
linking the sealing flap to a rear suspension assembly with a mechanical control arm such that the front edge is directed downward when the rear suspension assembly experiences braking forces exceeding a designed threshold.

15. The method of claim 12, wherein directing the front edge of the sealing flap downward occurs only during braking events.

16. The method of claim 12, wherein the sealing flap is operably connected to a duct member, whereby directing the front edge of the sealing flap downward further comprises:
exposing an inlet end of the duct member to the airflow whereby the airflow is directed through a continuous airflow path of the duct member to a distribution end of the duct member, whereby said airflow is directed out a distribution outlet and onto the rear brake assembly.

17. The method of claim 16, wherein the duct member comprises an inlet portion and a distribution portion, whereby exposing the inlet end of the duct member further comprises:
rotating the inlet portion about a pivot assembly connecting the inlet portion to the distribution portion, whereby the continuous airflow path remains define.

18. The method of claim 16, further comprising:
integrating the sealing flap into the duct member such that the sealing flap defines a bottom duct surface at the inlet end.
